(19) United States
(12) Patent Application Publication
(10) Pub. No.: US 2011/0178981 A1
(43) Pub. Date: Jul. 21, 2011

(54) COLLECTING COMMUNITY FEEDBACK FOR COLLABORATIVE DOCUMENT DEVELOPMENT

(75) Inventors: Nicholas S. Bowen, Somers, NY (US); Brian P. Gaucher, Yorktown Heights, NY (US); Zhu Han, Shanghai (CN); Wei Sun, Shanghai (CN)

(73) Assignee: INTERNATIONAL BUSINESS MACHINES CORPORATION, Armonk, NY (US)

(21) Appl. No.: 12/691,494

(22) Filed: Jan. 21, 2010

(51) Int. Cl. G06F 17/30

(52) U.S. Cl. 707/608; 707/E17.008; 707/737

(57) ABSTRACT

A Web based community feedback collection tool. The Web based community feedback collection tool is programmed to establish the linkage between the traditional document editing tools (e.g., MS Word, Powerpoint) and a Web based community feedback collection tool. A writer could get the summarized feedback generated from Reader/Web community directly when they open the document through the traditional document editing tool. The reader could provide feedback directly as well when they read the document through the document editing tool.

### BACKGROUND

The present invention relates generally to collaboration systems for authoring documents and, particularly, to a system and method for supporting the collection and aggregation of review feedback of a document from a community of readers for a writer's review while the document is being developed.

Documents are developed to facilitate communications between the writers and the readers. The documents are files with human readable format through document or presentation editing tools, for example: Microsoft Word®, Powerpoint®, Lotus Symphony®, and the like. In many cases or in certain stages of the document development process, the writer (e.g., author) would like to collect feedback from their co-writers and, for example, targeted readers. The feedback could be general comments or specific suggestion at the document level. The feedback is collected and used by the writers to, for example: polish and revise the document before its formal release/publication; understand readers' reactions before the face to face communications; and, plan actions based on the suggestions gathered from the feedback.

Face to face and teleconference meetings are the most effective ways to collect feedback, but they are very expensive because it is very difficult to bring people together at the same time and the same place. Further, both face to face and teleconferences are not scalable to collect feedback from a community of readers. The most widely used approach for feedback collection is e-mail. The writer sends the documents to a group of readers through email attachment, the readers write back emails with their feedback. This approach works but has the following problems: It is a time consuming task to filter/track the feedback emails from e-mail inbox, and, it requires a lot effort to summarize all the feedback from many emails (dozens or even hundreds of e-mails). Readers use email to write feedback but use other tool (e.g., MS Word®, Powerpoint®) to read the document, therefore feedback needs to be written in complicated way associated with the content context (e.g. page, slide) of the document. This requires additional effort to both readers and writers.

Recent approaches trying to solve these problems include, for example: Wild (e.g., http://en.wikipedia.org/wiki/) offers the capability for community users to write comments for the document shared on the Web, and supports authorized readers to edit the document directly by enabling users to go to a centralized place on the Web to read and comment on the documents.

Other Web based document sharing tools (e.g. slideshare.net; authorstream.com; show.zoho.com) enable users to go to a centralized place on the Web to read and comment the documents. These approaches are good at enabling community users to read the comment on the document. They require the writers and the readers of the document to use the Browser/Web as the tool. But these Web based tools are appropriate for sharing and reading. They require Internet connection and do not provide good enough editing capabilities. Most of users, especially the writers (authors), still prefer to use traditional document editing tool like MS Word® and Powerpoint®. This requires that users need to switch from different tools for collecting/providing feedback and editing/reading the document.

It would be highly desirable to provide a system and method that addresses the shortcomings of conventional Web-based document sharing tools by providing a Web based community feedback collection tool that enables document writers to obtain summarized feedback generated from a reader(s)/Web community directly when the writer opens the document through a document editing tool. The reader could provide feedback directly as well when they read the document through the document editing tool.

### SUMMARY

There is provided a system and method for providing a linkage between the traditional document editing tools (e.g., MS Word®, Powerpoint®) and a Web based community feedback collection tool. Based on the linkage, the writer could get the summarized feedback generated from Reader/Web community directly when they open the document through the document editing tool. The reader could provide feedback directly as well when they read the document through the document editing tool. To achieve this, a set of extensions are provided to the document editing tool, and, a centralized feedback management tool is provided to link the readers and the writers together in the document context.

More particularly, in one aspect, there is provided a method of performing collaborative document development comprising: storing, in a memory storage device, a document authored by a first user via a document editing tool; accessing, by at least two second users via respective client devices, the stored document; entering feedback content, by each the second user, relating to the accessed document or one or more sub-portions of the document via respective the client devices; storing the feedback content entered by each the second users as individual feedback items in the memory storage device, specifying, by the first user, particular feedback content directed to the document or sub-portions thereof; and in response, aggregating any stored feedback items directed to the specified document or a sub-portion thereof; presenting, via the first editing tool, the document including the aggregated individual feedback items associated with a specified the document or sub-portion thereof for the first user, wherein the first user obtains feedback generated from the at least two second users directly in the document for editing via the document editing tool, wherein a processor device performs at least one of the storing, accessing, aggregating and presenting.

In a further aspect, there is provided a document feedback management system comprising: a memory storage device for storing documents authored by first users via a document editing tool; at least two client devices via which respective at least two second users can access the stored document and enter feedback content relating to the accessed document or one or more sub-portions of the document; a feedback manager device receiving the feedback content entered by each the second users, and storing the entered feedback content as individual feedback items in the memory storage device, the feedback manager associating the individual feedback items with the particular document or document sub-portion; a browser device associated with the document editing tool through which a first user specifies particular feedback content directed to the document or sub-portions thereof, the feedback manager, in response, aggregating any stored individual feedback items as specified, and presenting, via the document editing tool, the document including the aggregated individual feedback items associated with a specified the document or sub-portion thereof for the first user, wherein the first user obtains feedback generated from the at least two second users directly in the document for editing via the first document editing tool.

In accordance with a further aspect, there is provided a computer program product for performing collaborative document development, the computer program product comprising: a storage medium readable by a processing circuit and storing instructions for processing by the processing circuit for performing a method comprising: storing, in a memory storage device, a document authored by a first user via a document editing tool; accessing, by at least two second users via respective client devices, the stored document; entering feedback content, by each the second user, relating to the accessed document or one or more sub-portions of the document via respective the document editing tools; storing the feedback content entered by each the second users as individual feedback items in the memory storage device, specifying, by the first user via the first editing tool, particular feedback content directed to the document or sub-portions thereof; and in response, aggregating any stored feedback items directed to the specified document or a sub-portion thereof; presenting, via the first editing tool, the document including the aggregated individual feedback items associated with a specified the document or sub-portion thereof for the first user, wherein the first user obtains feedback generated from the at least two second users directly in the document for editing via the document editing tool.

### BRIEF DESCRIPTION OF THE DRAWINGS

The objects, features and advantages of the present invention will become apparent to one ordinary skill in the art, in view of the following detailed description taken in combination with the attached drawings, in which:

FIG. 1 illustrates a system architecture 10 for providing collaborative document development according to one embodiment;

FIG. 2 illustrates a schematic diagram of the server side feedback management system including the extended document editor tool according to one embodiment;

FIG. 3A illustrates a process 200 implemented by the system of FIGS. 1 and 2 for registering a document to be subject to review/feedback;

FIG. 3B illustrates a process 240 implemented by the system of FIGS. 1 and 2 providing functionality to enable a user to provide and publish document feedback;

FIG. 3C illustrates an example Server Side Feedback Manager process 250 for document readers connected to the system via a Web interface;

FIG. 3D illustrates an example Client Side Feedback Manager process 275 for document readers connected to the system via a Web interface;

FIG. 3E illustrates an example process 290 for enabling clients to publish the feedback to the server side feedback manager;

FIG. 3F illustrates an example process 230 for enabling clients to retrieve the feedback from the server side feedback manager;

FIG. 3G illustrates a further example process 215 for enabling clients to mark all feedback as read by the server side feedback manager;

FIG. 3H illustrates a further example process 260 for generating feedback metadata;

FIG. 4 illustrates an exemplary feedback browser 100′ showing an editing tool interface 98 with which a user may enter feedback content associated with a document or sub-portion, e.g., a slide;

FIG. 5 illustrates an example of the feedback metadata content 400 and attributes generated in one embodiment; and,

FIG. 6 illustrates an exemplary hardware configuration of a computing system 410 running and/or implementing the methods of the described embodiments.

### DETAILED DESCRIPTION

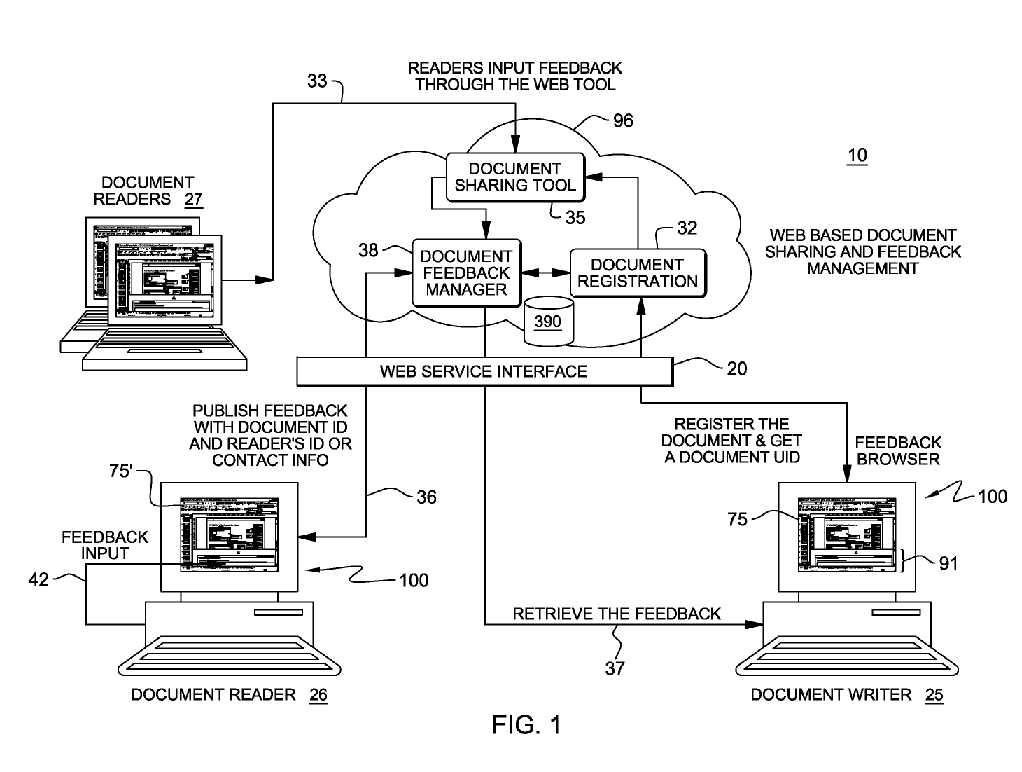

FIG. 1 illustrates a system 10 for providing collaborative document development according to one embodiment of the invention. In the system 10, there is provided a computing device, such as a web server, providing a web service interface 20 that enables multiple users through conventional tools to collaborate in document development activities in a more meaningful and efficient manner. Providing the web service interface is a web server configured to implement a server side feedback management system 10 for establishing the necessary linkages for collecting community feedback for collaborative document development.

Behind the web-based interface 20 through which users interact via a web browser such as a MS Windows®/Mac/Linux-based Firefox® browser, or, e.g., Internet Explorer® 7, for example, on either an attached or externally connected computing device (a client device such as a desktop, laptop, mobile computing device or pervasive digital device, etc.)), a web service interface (web pages) is provided for at least two user types: 1) document writers 25 and document readers 26. For the document writers 25, the system generates for web browser display on the writer's client a document editing tool, providing editing tools functionality, e.g., MS Office®, Word®, Powerpoint®, Mac iWork®, OpenOffice® and its variants, Adobe Acrobat professional, Tex® and its variants, etc., that has been enhanced with extended functionality to enable users to collaboratively create/edit a document 75 according to procedures described in detail below that include by providing through conventional editing tool the ability to receive collaborative feedback. For the document readers 26, via a web-based (network) connection 36 (e.g., an HTTP session connection) enabling communication from their client device to the web interface 20, the system generates for display on a client web browser the document 75′ which is to be reviewed and for which feedback 42 is to be input according to procedures described in detail herein below. The web service interface 20 in particular comprises an application programming interface (API) that provides a mechanism for the document sharing tool or the web browser (e.g., Internet Explorer® or Mozilla® Firefox) to publish the feedback automatically to the feedback manager on the remote server side. These API are hidden by the document tool or the web browser and may be implemented by, e.g., Representational State Transfer (REST) or Simple Object Access Protocol (SOAP).

In an alternate embodiment, document readers 27 may access a document to be reviewed directly via a direct (e.g., local wired or wireless) connection 33 from their client device (e.g., a desktop, laptop, mobile computing device or pervasive digital device, etc.) to the document sharing tool 35 as depicted in FIG. 1. In this embodiment, a document may be presented for display for the reader 27 to provide direct feedback input through the client (editing tool) and bypassing the web interface 20. Thus, there are two types of readers: One user 26 who uses his/her web browser like Mozilla® Firefox to read the documents and provide feedback. The other user 27 who uses a document editing tool, e.g., Word, installed with a feedback browsing plug-in, to read the document and provide the feedback.

As shown in FIG. 1, the server side feedback management system 10 invokes functionality to establish a link between a traditional document editing tool and a web based community feedback collection service to provide for document writers 25, a Web based community feedback browser 100 that configures for presentation to the writer (or author) a user interface providing summarized feedback 91 generated (and stored) from reader(s) or a web-based “community” directly when the author or writer opens up the document 75 through the document editing tool. In an embodiment depicted in FIG. 1, a document writer 25, via a web-based network connection 37 (e.g., an HTTP session connection) to the web interface 20, is enabled to register document(s) authored by the writer 25 that can be subsequently or immediately accessed for review by one or more readers 26, 27 via their web browser, and receive feedback accordingly from the reader(s).

The server side feedback management system provides, as shown in FIG. 1, a web service interface 20 and interconnected components including a document registration system 32, a document sharing tool 35 and a document feedback manager 40 the functionality of which is to be described in greater detail herein below. That is, the server side feedback management system 10 including document registration 32, a document sharing 35 and a document feedback manager 38 components, enables a writer 25, through their feedback browser 100, to register a created document or work of authorship, associate a unified document identifier (UID) to that document for establishing the linking and facilitating document feedback management, and, store the document in a memory/data storage device database, e.g., database 390, which may comprise memory, e.g., RAM, ROM, CD-ROM, DVD-ROM, and other semiconductor, optical and/or magnetic memory storage devices.

The server side feedback management system shown in FIG. 1, enables a document reader 27 to provide immediate feedback 96 to a composed document directly, for those who do not have a network connection or working off-line, for example, by use of document editing software and a feedback browser plugin, the user can access or comment the document off-line, or alternatively, enable a reader 26 to provide feedback 42 via an on-line network connected client when they open the document 75′ through the internet browser, e.g. Mozilla Firefox®, to access the document and enable a user to provide feedback content to (e.g., annotate) the published document. To accomplish this, the server side feedback management system 10 links the readers 26 and writers 25 together in the document text. A set of extensions is provided to the document editing tool, and the server side feedback management links the readers and the writers together in the document context.

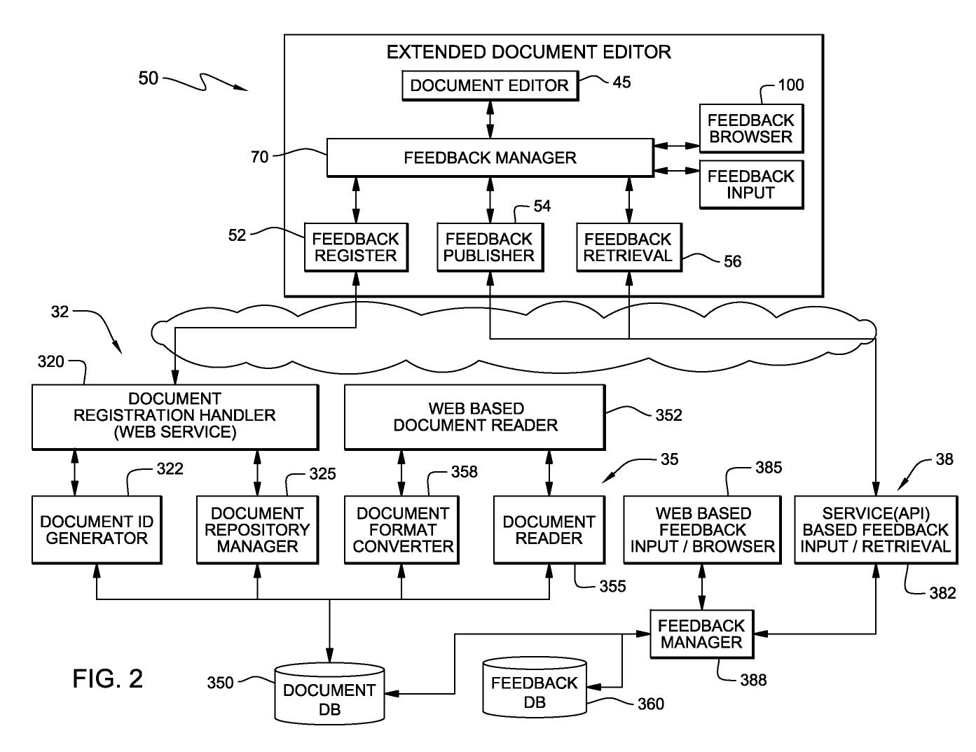

As further shown in FIG. 2, the Document Registration component 32 (of FIG. 1) comprises further components including: a Document Registration Handler component 321 which is a web service called upon to assign a document ID to a document to be subject to community feedback. Particularly, as shown in FIG. 2, the Document Registration Handler component 320 web service of the server side feedback management system 10 provides the API (web services application programming interface) that enables a document writer to register his/her document in the document database 350 with the UID. Particularly, the Document ID generator 322 is a software module that may be invoked via the web service in order to generate the UID with which users can indicate to access any particular document for any purpose, e.g., a writer publishing a document for review, a writer reviewing community feedback, etc. Further, a Document Repository Manager 325 provides all of the management access and storage functions relating to the documents that are subject to community review. For example, a document writer registers his/her document in the Document Database 350 associated with a unified ID. The document can be uploaded through the interface and put into the “Document Database” as well. The document unified ID is subsequently used for a writer to retrieve all the feedback related with the specific document. All the readers' feedback is managed by the unified document ID as well.

As further shown in FIG. 2, the Document Feedback Manager component 38 (of FIG. 1) comprises further components including: a Service API (web services application programming interface) 382 that enables a user to indicate feedback management functions relating to feedback input/retrieval and, a web-based component 385 enabling readers to provide the feedback and/or perform web-based input/browse functions. Both the Service API 382 and the web-based feedback input/browse function 385 operatively interact with feedback manager component 388 that provides all of the management access and storage functions relating to all users' feedback items that are stored in a memory/data storage device, e.g., a feedback database 360. For example, the feedback “Handler” 382 provides the API (e.g. web service interfaces) for readers to publish/retrieve feedback to a document and the Feedback Manager module 388 is responsible to perform functions such as, but not limited to: Add/delete/query/list feedback stored in the “Feedback Database” 360. It is understood that, in alternate embodiments, the Feedback Database access 360 and the Document Database 350 may comprise a single standalone database 390, as shown in FIG. 1.

As further shown in FIG. 2, the Document Sharing Tool 35 (of FIG. 1) comprises further components including: a Web based Document Reader 352 that enables readers to read the document using a Web based tool. It is composed of a “Document Reader” component 355 and a “Document Format Converter” component 358 that provide the tool for presenting the document to the user for purposes of review and remote entry of feedback. The “Document Reader” and “Document Format Converter” components can comprise existing off-the-shelf components. All of the readers' feedback is managed by the document unified ID.

In FIG. 2, the community based feedback input/retrieval component 382 provides the ability for users to: use a single preferred tool to read/author document as well as provide feedback to the document; provide document authors with the ability to obtain specific feedback to a specific portion of their authored document, e.g., page, section, paragraph; provide the ability of document authors to collect feedback from a community of readers even though they may not know who the readers exactly will be. Thus, in one aspect, the reader and writer interact without the need to switch between editing tools and they each may use a traditional editing tool to get or provide feedback in addition to reading/editing the document, thereby improving the work efficiency for both the writers and readers.

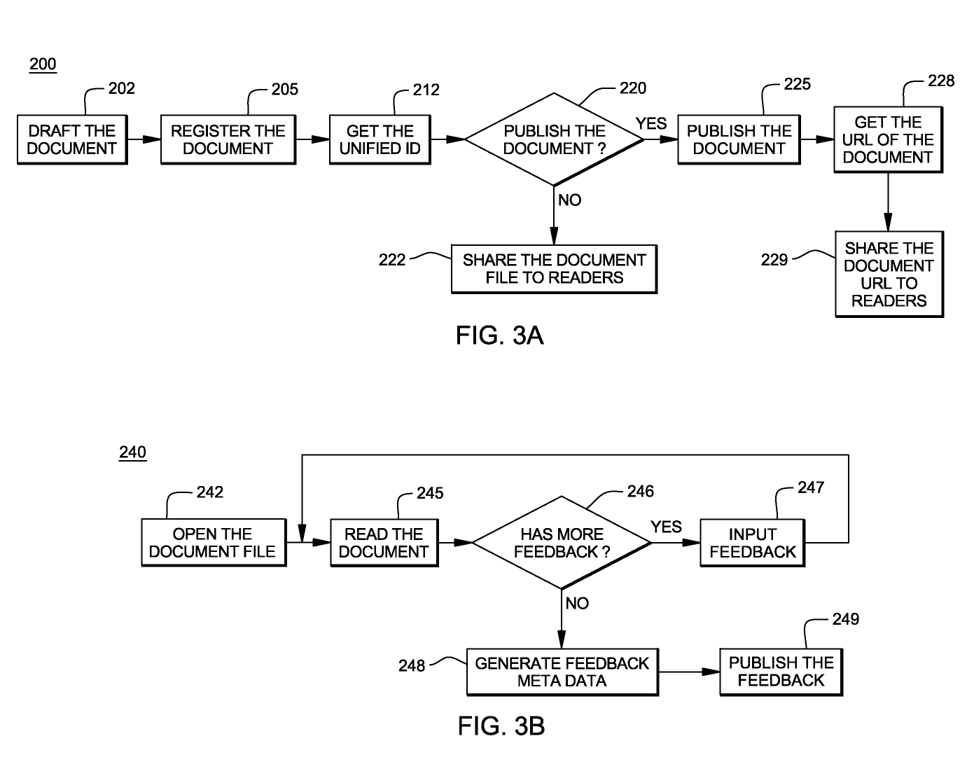

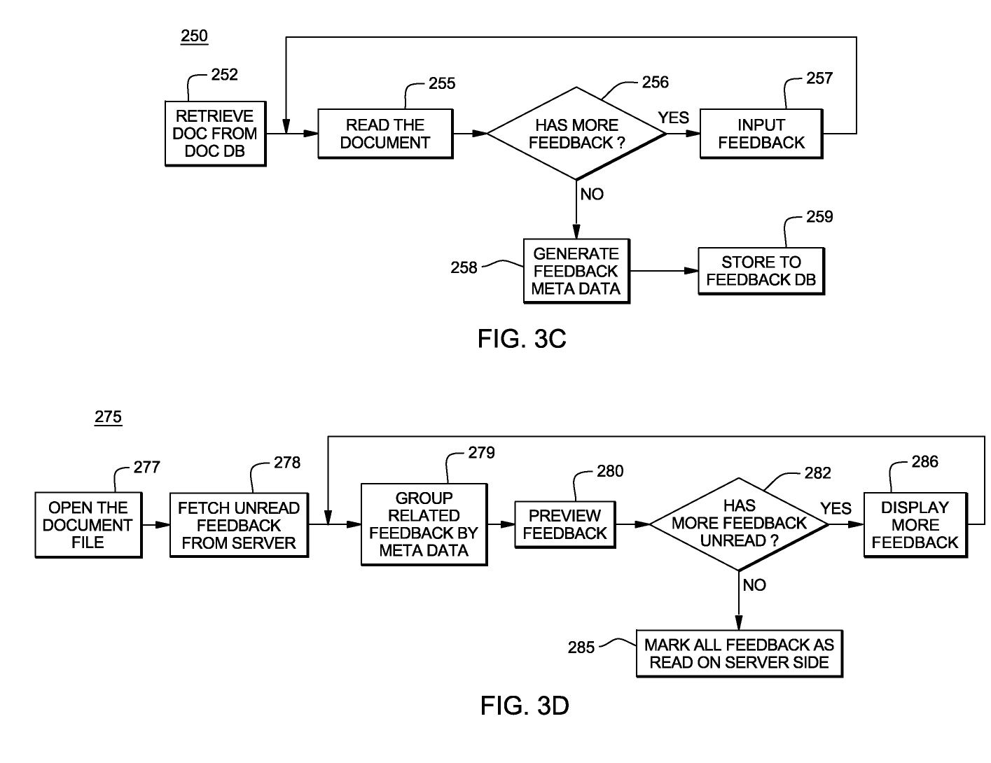

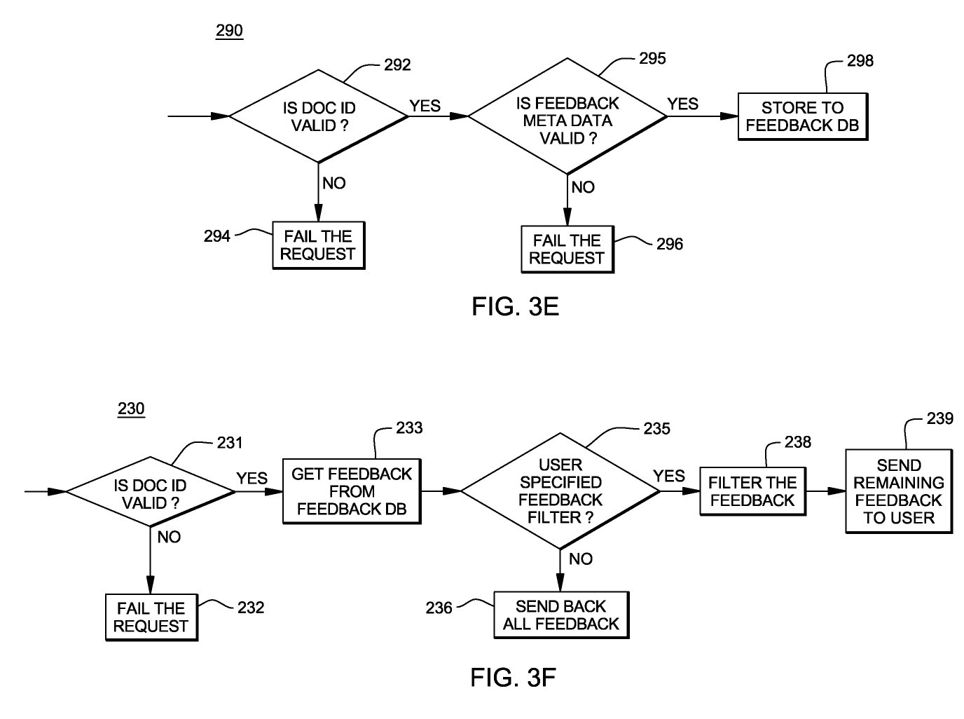

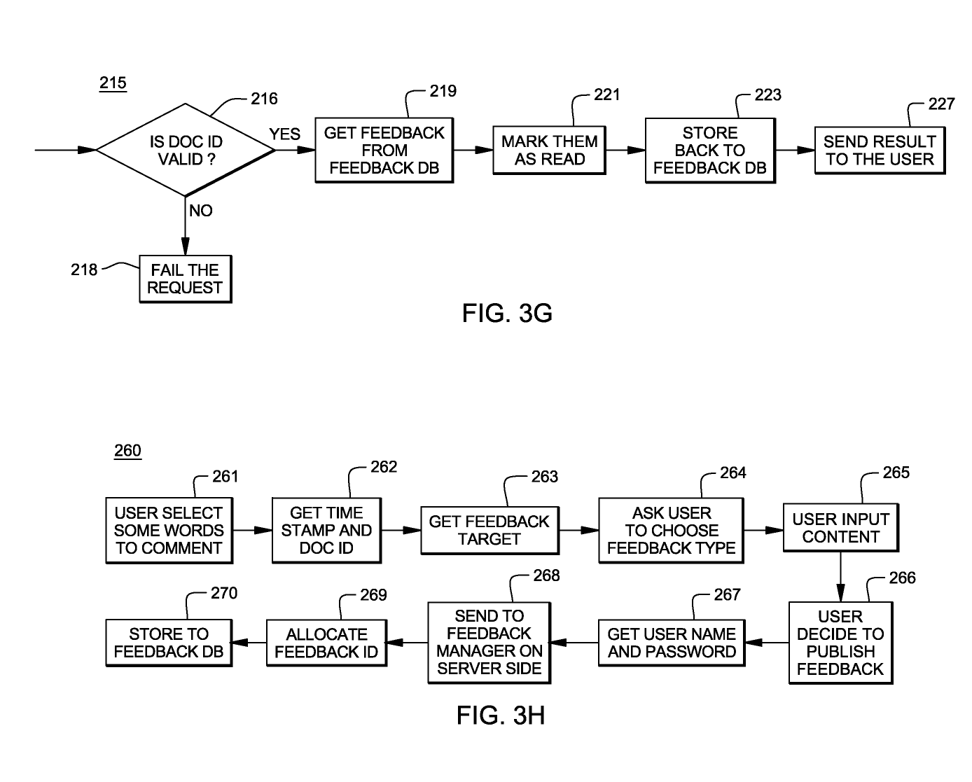

As further shown in FIG. 2, the Document Editor 45 itself is enhanced to provide an “Extended” Document Editor 50 that facilitates the feedback generation function for readers 26. The “Extended Document Editor” includes a conventional document editor tool (e.g. MS Powerpoint®, MS Word®, Presentation, etc.) indicated as document editor 45. The extensions built to the editor include: a “Document Register” module 52 responsible to interact with the registration service on the server side to obtain a document unified ID; a “Feedback Input” module 54 that provides the tools, such as web-based annotation tools, for users to add comments or make suggestions to the document within the editor; a “Feedback Publisher” module 56 that is responsible to upload all the comments/suggestions input within the editor into the server side feedback management service; and, a “Feedback Retrieval” module 58 that is responsible to interact with server side feedback management service 10 to download all the feedback information about a particular document, or sub-portion thereof, into the document editor for display at the user's browser. The extended document editor 50 functions described herein further provide a “Feedback Browser 100 for a user (e.g., writer) to browse all the feedback. A “Feedback Manager” module 70 inside the extended editor is linking all the extended components with the editor. Details regarding operation of the Feedback manager 70 for the client will be shown in greater detail herein below with respect to FIGS. 3B and 3D.

FIG. 3A illustrates a process 200 implemented by the system of FIGS. 1 and 2, for registering a document to be subject to review/feedback according to the present invention. In the process 200, there is first performed at 202 the drafting of a document (which may include text, graphics, objects, URL or hyperlinks and/or other information that may be composed as a document) via the extended document editor. Then, the user (writer) registers the document with the server side management system at 205 to establish the server-side capabilities. This action includes sending a request to the document registration web service which then fetches the result. Particularly, the document registration handler 320 of the server side feedback management functionality shown in FIG. 2 is invoked at this step to assign a unique document identifier (document ID, or, alternately referred to as a unified ID) to the document and storing the document in the database 350 for writer or reader access as shown. That is, as a part of the registration process, the document ID is assigned to the document at 212 for purposes of linking users and tracking document usage by the server side feedback management system. Continuing, a decision is made at step 220 to determine whether the drafter (writer) is to publish the document, i.e., make the document available to an indeterminate group of users and/or subscribers, e.g., associates, friends, clients, peers or colleagues. If the document is to be published, then an action is provided to send the request to the document registration web service which then fetches the result so that the document is published at step 225 using conventional publication/subscription (pub/sub) technique and the process proceeds to step 228 where a URL is associated with the document to be shared. It is noted that off-the-shelf publication software components may be implemented to push the feedback to the writer immediately. In one embodiment, it is the URL representing the location of the document that is shared with readers as indicated at step 229, FIG. 3A and the process ends. Alternately, if the decision step 220 indicates that no decision to publish the document has been made, then the document file is shareable with the reviewers (readers) in which case the document may be directly e-mailed or otherwise communicated to available selected reviewers at 222 and the process ends.

FIG. 3B illustrates a process 240 implemented by the system of FIGS. 1 and 2, providing functionality to enable a user to provide feedback to the document. In the process 240, there is first performed at 242 the opening up of a drafted document. It is understood that, as part of this step, a user (reader) has entered a document ID (Unified ID) via their browser interface to ensure the correct document is being accessed for review and, so that the server side feedback manager can coordinate all of the connections for enabling annotation to the document via that user's browser. Having accessed the specified document, the user (reader) reads the document at 245 and provides any feedback on the document's content, at any granularity, e.g., a chapter, page, paragraph, slide, line(s), figure, etc. At step 246, a determination is made as to whether the reader has any more feedback to enter. If there is more feedback to enter, the process proceeds to step 247 where the user enters additional feedback content, and the process returns to step 245. Otherwise, if at 247, it is determined that the reader has no more feedback to enter, then the process proceeds to step 248 where the system automatically generates feedback metadata and, publishes the feedback at step 249.

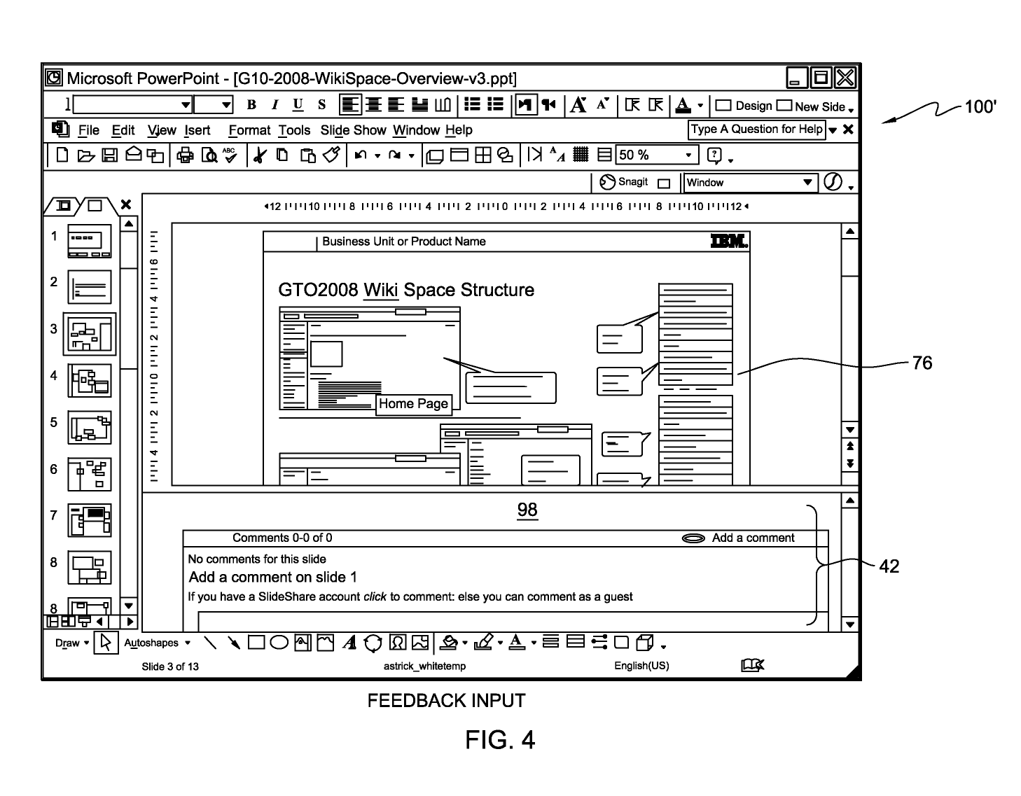

FIG. 4 illustrates an exemplary feedback browser 100′ showing an editing tool interface presenting a frame or interface portion 98 with which a reader may enter feedback content 42 associated with a document or sub-portion, e.g., such as a MS Powerpoint® slide 76. The conventional editing functions provided by the editing tool are used by the reader to enter the feedback.

In one embodiment, the document feedback is provided by the readers 26, 27 in the form of annotations to such documents as may be input according to the teachings of U.S. Pat. No. 7,299,407, the whole contents and disclosure of which is incorporated by reference herein, directed to the marking and annotating of electronic documents where a user can highlight text and provide accompanying annotations. Alternately, the feedback may be provided by the readers 26, 27 in the form of annotations such as may be input according to the teachings of U.S. Pat. No. 6,859,909, the whole contents and disclosure of which is incorporated by reference herein, directed to a system and method for annotating web-based documents. Via this teaching, computer users can integrate any annotation, including ink, highlighter, text-based notes and audio, directly into a Web-based document (WBD) displayed by the feedback browser. Alternately, the feedback may be provided by the readers 26, 27 by providing a web service akin to the Notate 2.0 web site (http://beta2.textensor.com/) which is a web-site providing a web-based tool for annotating and tagging words and phrases within documents. Alternately, the feedback may be provided by the readers 26, 27 in the form of annotations such as may be input according to the teachings of U.S. Pat. No. 6,950,982, the whole contents and disclosure of which is incorporated by reference herein, directed to an active annotation mechanism for document management systems wherein annotations on a document which may be in the form of in-line annotations and out-of-band annotations, and which may be inputted through a variety of input devices, can be detected. Moreover, another embodiment implements functionality such as currently available in Wild (www.wikipedia.com) as this technology offers the capability for community users to write comments for a document shared on the Web, and supports authorized readers to edit the document directly.

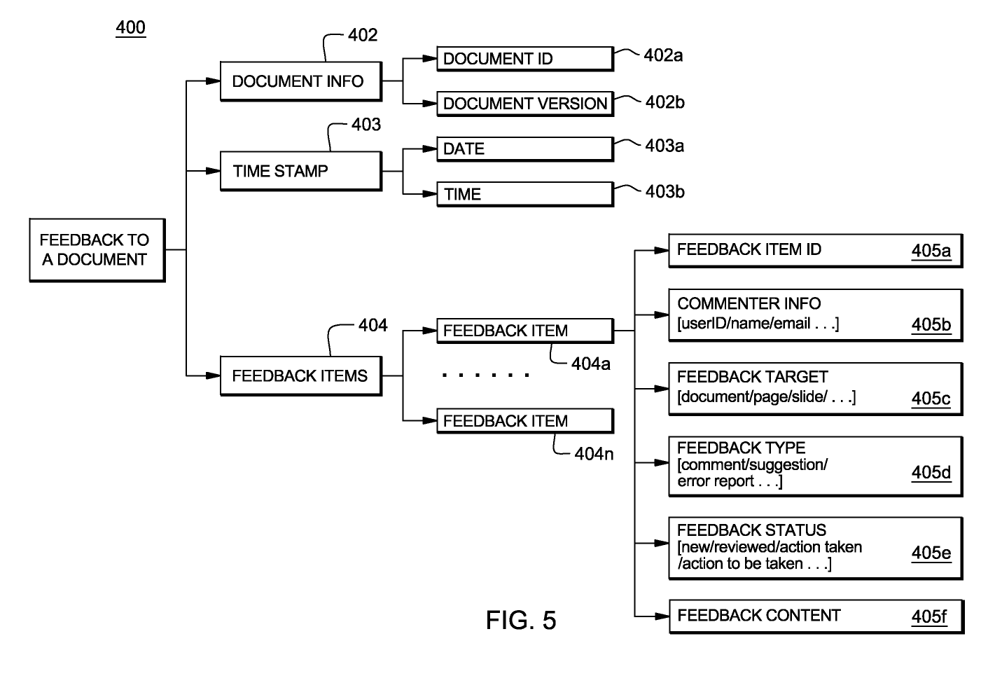

FIG. 5 illustrates the feedback metadata content 410 generated at step 248, FIG. 3B. As shown in FIG. 5, the metadata content includes, but is not limited to, the following attributes: the document information 402, such as, for example, the document type 402a or, the document version 402b; a time stamp information 403 including the date the feedback was generated 403a and the time 403b; and, the actual feedback items 404 including items 404a, . . . , 404n, wherein each feedback item 404a, . . . , 404n includes, but is not limited to: a feedback Item ID 405a, a commenter information 405b such as a userID, name, e-mail address, etc.; a feedback target 405c to indicate the document and/or any sub-portion thereof to which the feedback is directed, e.g., document, page, chapter, figure, paragraph, sentence, slide, etc.; a Feedback Type 405d to indicate the structure of the feedback, e.g., whether in the form of a comment, suggestion, error report, etc.; a Feedback Status 405e to indicate the status of the feedback, i.e., whether it is new, reviewed, whether it constitutes action taken or, action to be taken, etc.; and, a feedback content 405f. This metadata information is stored in the feedback information database 360 shown in FIG. 2 via the Web Service based feedback Input/retrieval (API) 382 and feedback manager 388 elements.

Feedback metadata is generated in one embodiment according to the process 260 illustrated in FIG. 3H. As shown in FIG. 3H, a first step includes the selecting of the locations or content (e.g., words) in the document for which user feedback s is to be generated at 261, and the indicating of the associated Document (Document ID) and a time stamp value indicating when feedback is provided for recordation at 262. The user at 263 additionally indicates a “feedback target”, which is the position of the words in the document targeted by the feedback. As mentioned, the feedback target 405c indicates the document and/or any sub-portion thereof to which the feedback is directed. At step 264, the user is then prompted to choose a feedback type which indicates the structure of the feedback, and the user enters the feedback content at 265. Once the feedback content is entered, the user is prompted whether to publish the feedback. If the decision is made to publish, then the user name and password are entered (267) and the feedback is sent to the feedback manager on the server side (268). The server side feedback manager then indicates for the feedback to be published, a feedback Item ID for identifying the particular feedback item at 269 and the feedback item (metadata and the content) are stored in the relational database at 270. It is understood that each feedback item will be allocated as an unique ID. Thus, in operation, an item in the meta data of feedback is indexed to facilitate the retrieval, e.g., doc ID and user name.

FIG. 3C illustrates an example Server Side Feedback Manager process 250 for document readers connected to the system via a Web interface. The process is similar to the process as described in connection with the client side feedback manager, however, with a first step performed at 252 which is directed to retrieving a drafted document from the document database based on the document ID indicated by the user to ensure the correct document is being accessed for review. The server side feedback manager coordinates all of the connections for enabling comment entry or annotation to the document via that user's browser. Having accessed the specified document, the user (reader) reads the document at 255 and provides any feedback on the document's content, at any granularity, e.g., a chapter, page, paragraph, slide, line(s), etc. such as described in connection with FIG. 4 and the feedback metadata generated and feedback stored in connection with FIG. 3H. At step 256, a determination is made as to whether the reader has any more feedback to enter. If there is more feedback to enter, the process proceeds to step 257 where the user enters the feedback, and the process returns to step 255. Otherwise, if at 257, it is determined that the reader has no more feedback to enter, then the process proceeds to step 258 where the user generates feedback metadata which is communicated for storage in the feedback database 360 via the feedback publisher module 54 (FIG. 2) in communication with web service at step 259.

After feedback content (e.g., annotations) are made to a document according to the techniques described herein, the system's Client Side Feedback Manager element 70, FIG. 2, functions to display the community feedback to writers of the document. In one embodiment, using off-the-shelf pub/sub technology, the server side feedback manager can push the feedback to the writer immediately, e.g., by implementing HTTP COMET; however, other standard pub/sub interfaces are also embraced. That is to say, the server side feedback manager is enabled to push recently updated feedback provided by the reviewer to the document writer real timely.

FIG. 3D illustrates an example Client Side Feedback Manager process 275 for document readers connected to the system via a Web interface. As shown at step 277, FIG. 3D, the process begins by having a writer opening up a document file, for example, in response to selecting a document indicated by that document's ID entered via the web-service interface. Then, in cooperation with the feedback retrieval element 56 (FIG. 2) the unread Feedback is fetched from the Server—particularly via the server side Feedback manager element 388 and web service 382. The process proceeds to step 279 where the related feedback is grouped according to the stored meta data, such that the relevant unread feedback is presented to the user. In this instance, for example, the writer may only want feedback information directed to the document, or, for example, a particular sub-portion such as a paragraph of the document being reviewed. In this instance, a query is established by the writer to retrieve, i.e., sort and aggregate (group) all feedback items directed to that document or document sub-portion (e.g., page, paragraph, slide, figure, outline section). Each of the aggregated feedback items and feedback content is displayed for the writer for review as indicated at step 280. A decision is entered at step 282 to determine whether all of the community feedback has been reviewed. If all of the community feedback has been reviewed, then the process proceeds to step 285 where all feedback is marked as being read on the server side. Otherwise, at step 282, if some of the community feedback remains unread, the process proceeds to step 286 where more feedback is displayed for the writer to review and the process returns to step 279 to aggregate any additional feedback for display.

Thus, according to this embodiment, in one example scenario, a user (writer) may input or specify, via a user interface, a feedback filter used to facilitate the writer to read the feedback and comprises any criteria to organize or hide some feedback when being displayed. For example, a filter may be specified to retrieve “feedback only from reader A”, which the system will respond by grouping only the feedback items entered from user A and display only those items for the user (writer). If, for example, the filter is indicated by the writer as “feedback only for the first slide”, only the feedback items on the first slide entered by those users who had entered feedback regarding this first slide would be grouped for display. If, for example, the filter indicates “sorting the feedback by timestamp”, then all feedback are grouped for display e.g., in a manner ascending by timestamp.

FIG. 3E illustrates an example process 290 for enabling clients to publish the feedback to the server side feedback manager. Particularly, as shown in FIG. 3E, the server side feedback manager 388 (FIG. 2) performs a step 292 of determining whether the entered document ID identifying the document to be reviewed is a valid document ID. If the entered document ID does not match any document ID having associated feedback stored, then the request has failed and the process terminates at step 294. Otherwise, the process continues at step 295 where it is determined whether the feedback metadata generated for that document ID is valid. Feedback metadata is valid when the user name is a valid user and when time stamp, feedback target and feedback content is set.

If the generated feedback metadata is not valid, then the request has failed and the process terminates at step 296. Otherwise, the process continues at step 298 where the feedback and associated feedback metadata is stored at the feedback database 360 (FIG. 2).

FIG. 3F illustrates an example process 230 for enabling users to retrieve the feedback from the server side feedback manager. As shown at first step 231, there is determined whether the entered document ID identifying the document to be reviewed is a valid document ID. If the entered document ID does not match any document ID having associated feedback stored, then the request has failed and the process terminates at step 232. Otherwise, if the entered document ID does match a document ID having associated feedback stored, the process continues at step 233 where the feedback is retrieved from the feedback database DB 360. Then, at 235, a determination is made as to whether the user has specified a feedback filter. For example, a filter indicates to the feedback manager component which particular items to include for presentation to the document writer. For example, in one embodiment, a filter may include entry fields for specifying or indicating feedback metadata associated with the individual feedback items (e.g., annotations or other feedback content) to not include for a particular identified document or document sub-portion being accessed. Alternately, the filter may include entry fields for specifying or indicating feedback metadata associated with the individual feedback items to include for a particular identified document or document sub-portion. At step 235, if it is determined that the user has not specified a feedback filter, then all feedback items associated with the document are sent to the user as indicated at 236. Otherwise, if at 235 the user has specified a feedback filter, then the process continues at step 238 where the individual feedback items indicated by the feedback metadata specified by the filter are filtered out. Then, at 239, the remaining (unfiltered) feedback is retrieved from the feedback database and is sent to the user for review.

In another embodiment, the server side feedback manager does not handle the feedback filter. All feedback is pushed to the client side plugin/web browser, which enforces the filter to the data and then determines which feedback item(s) to display to the user. That is, the feedback filter graphic user interface (GUI) is applied on the client side in the form of a client side feedback plugin that receives all feedback from the server side and then determines which feedback should be displayed on the GUI based on the feedback filter. For a web browser, javascript code on the browser side would take the role of client side feedback and the filtering would be performed on the client side in order to get the real time response when the user changes the filter.

One implementation of the feedback filter GUI is provided on the client browser as a single text entry box wherein a user inputs requested feedback text, e.g., specifying a reader or reviewer, for example, in which case the GUI would display only the feedback from that reader or reviewer. The javascript running at the client is a simple text search tool based on the meta data of feedback. There are other ways to implement this, e.g., as a full text search based on relational database, or text indexing like in a web search engine.

In one embodiment, the feedback database 360 may be configured as a relational type database such that feedback metadata and associated feedback content is searchable via standard query commands. Thus, the feedback may be “grouped” together which have some similarity from the perspective of metadata to facilitate the writer to view the feedback. Thus, for example, the feedback from the same user or the feedback on the same document or sub-portion, e.g., paragraph, can be grouped based on metadata sort functionality (i.e., filter). In other words, the user can sort the feedback by the name of the user or other context information (specified metadata attributes) for immediately view.

FIG. 3G illustrates a further example process 215 for enabling clients to mark all feedback as read by the server side feedback manager 10. As shown at first step 216, there is determined whether the entered document ID identifying the document to be reviewed is a valid document ID. If the entered document ID does not match any document ID having associated feedback stored, then the request has failed and the process terminates at step 218. At step 219, FIG. 3G, the feedback specified according to the document ID is retrieved from the feedback DB. Then, at 221, the feedback is marked as being read and is stored back to the feedback database at step 223. Subsequently, the result that all of the feedback has been read is sent to the user at step 227.

Thus, the embodiments described herein enable generation/receipt of feedback at various levels of document granularity, e.g., at the page, section or line level, from known (i.e., pre-defined set of readers (their names, email addresses)) and unknown readers (e.g., different people in the community), which a document writer can map to the specific area of the document. The myriad feedback content generated by and obtained from plural readers is further stored and the feedback management tool associates the feedback with a metadata that can be searched via database query commands, e.g., SQL. In this manner, document feedback from many users directed to at any level of document granularity may be aggregated for presentation to the user at once. The system 10 according to one aspect of the present invention establishes the linkage between the traditional document editing tools (MS Word, Powerpoint) and the Web based community feedback collection tool so that the writer could get the summarized feedback generated from Reader/Web community directly, e.g., when the writer opens the document through the document editing tool. The reader could provide feedback directly as well when they read the document through the document editing tool. The set of extensions such as shown in FIG. 2 need to be made to the document editing tool, a centralized feedback management tool need to be provided to link the readers and the writers together in the document context.

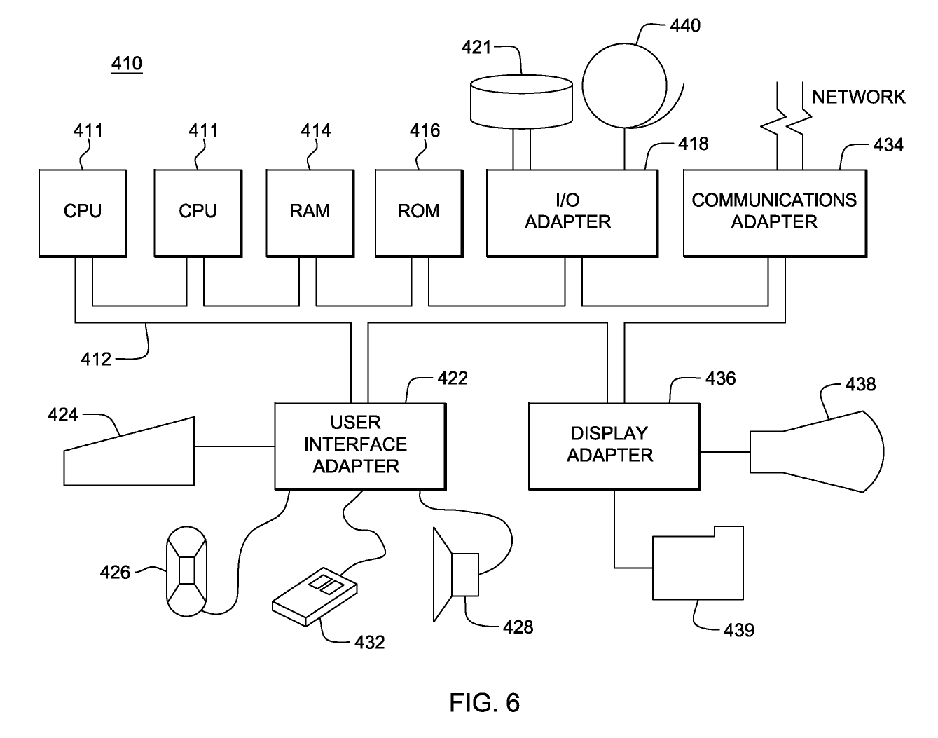

FIG. 6 illustrates an exemplary hardware configuration of a computing system 410, such as a web server device, running and/or implementing the method steps in FIGS. 3A-3G. The computing system 410 preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 410 to a data processing network, the Internet, an Intranet, a local area network (LAN), etc., and a display adapter 436 for connecting the bus 412 to a display device 438 and/or printer 439 (e.g., a digital printer of the like).

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and run, controls the computer system such that it carries out the methods described herein. The present invention can also be embedded in a computer program product, which comprises all the features enabling the implementation of the methods described herein, and which—when loaded in a computer system is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions runnable by the machine to perform method steps for causing one or more functions of this invention.

The present invention may be implemented as a computer readable medium (e.g., a compact disc, a magnetic disk, a hard disk, an optical disk, solid state drive, digital versatile disc) embodying program computer instructions (e.g., C, C++, Java, Assembly languages, Net, Binary code) run by a processor (e.g., Intel® Core™, IBM® PowerPC®) for causing a computer to perform method steps of this invention. The present invention may include a method of deploying a computer program product including a program of instructions in a computer readable medium for one or more functions of this invention, wherein, when the program of instructions is run by a processor, the compute program product performs the one or more of functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method of performing collaborative document development comprising:
storing, in a memory storage device, a document authored by a first user via a document editing tool;
accessing, by at least two second users via respective client devices, said stored document;
entering feedback content, by each said second user, relating to said accessed document or one or more sub-portions of said document via respective said client devices;
storing said feedback content entered by each said second users as individual feedback items in said memory storage device,
specifying, by said first user, particular feedback content directed to said document or sub-portions thereof; and in response,
aggregating any stored feedback items directed to said specified document or a sub-portion thereof;
presenting, via said first editing tool, said document including said aggregated individual feedback items associated with a specified said document or sub-portion thereof for said first user,
wherein said first user obtains feedback generated from the at least two second users directly in said document for editing via said document editing tool,
wherein a processor device performs at least one of said storing, accessing, aggregating and presenting.

2. The method as claimed in claim 1, wherein said document editing tool for authoring by a first user and said respective client device for entering feedback content by a respective second user implements a same text or presentation editing program.

3. The method as claimed in claim 1, wherein prior to storing said individual feedback items, said method comprising:
generating a metadata associated with said entered feedback items;
publishing said individual feedback items and associated metadata in said memory storage device.

4. The method as claimed in claim 3, wherein said aggregating stored feedback items comprises:
grouping related stored feedback items by their associated metadata prior to accessing.

5. The method as claimed in claim 4, wherein a said published associated metadata associated with feedback items include associated metadata attributes, said specifying comprising:
implementing a filter to specify metadata attributes to enable filtering out of particular feedback items from said document, said filter enabling said grouping of specific feedback items based on said specified metadata attributes.

6. The method as claimed in claim 5, wherein said metadata attributes includes: a feedback item identifier (ID); information about a second user providing said feedback comments; a feedback target including a document or sub-portion thereof; a feedback type; a feedback status; and, a feedback content.

7. The method as claimed in claim 1, wherein said document sub-portion includes: a document page, a document paragraph, one or more text lines, a slide, or a figure of said document.

8. The method as claimed in claim 1, wherein prior to storing a document authored by a first user, said method further comprising:
registering said document authored by said first user with a feedback management system, said feedback management system assigning a document identifier (ID) to said stored document.

9. The method as claimed in claim 8, further comprising: specifying, via a browser device associated with said first or second user, an associated document identifier (ID) for accessing said stored document.

10. The method as claimed in claim 8, wherein said feedback management system implements:
tracking feedback items accessed by said first user and feedback items yet to be accessed by said first user;
providing indication to a user as to feedback items that remain to be accessed.

11. A document feedback management system comprising:
a memory storage device for storing documents authored by first users via a document editing tool;
at least two client devices via which respective at least two second users can access said stored document and enter feedback content relating to said accessed document or one or more sub-portions of said document;
a feedback manager device receiving said feedback content entered by each said second users, and storing said entered feedback content as individual feedback items in said memory storage device, said feedback manager associating said individual feedback items with said particular document or document sub-portion;
a browser device associated with said document editing tool through which a first user specifies particular feedback content directed to said document or sub-portions thereof, said feedback manager, in response, aggregating any stored individual feedback items as specified, and presenting, via said document editing tool, said document including said aggregated individual feedback items associated with a specified said document or sub-portion thereof for said first user,
wherein said first user obtains feedback generated from the at least two second users directly in said document for editing via said first document editing tool.

12. The system as claimed in claim 11, wherein said document editing tool for authoring by a first user and client devices for entering feedback content by said second user implements a same text or presentation editing program.

13. The system as claimed in claim 11, wherein prior to storing said individual feedback items, said feedback manager generates a metadata associated with said entered feedback items and publishes said individual feedback items and associated metadata in said memory storage device.

14. The system as claimed in claim 13, wherein said aggregating of stored feedback items performed by said feedback manager comprises grouping related stored feedback items by their associated metadata prior to accessing.

15. The system as claimed in claim 14, wherein a published metadata associated with feedback items include associated metadata attributes, said feedback manager device presenting a filter to enable a user to specify metadata attributes for filtering out of particular feedback items from said document, said filter enabling said grouping of specific feedback items based on said user specified metadata attributes.

16. The system as claimed in claim 15, wherein said metadata attributes includes: a feedback item identifier (ID); information about a second user providing said feedback comments; a feedback target including a document or sub-portion thereof; a feedback type; a feedback status; and, a feedback content.

17. The system as claimed in claim 11, wherein said document sub-portion includes: a document page, a document paragraph, one or more text lines, a slide, or a figure of said document.

18. The system as claimed in claim 11,
a document registration handler for enabling said first user to register said document authored by said first user with said system, and assigning a document identifier (ID) to said stored document.

19. The system as claimed in claim 18, further comprising: specifying, via a browser device associated with said first or second user, a document identifier (ID) for accessing an associated said stored document.

20. The system as claimed in claim 18, wherein said feedback manager device further tracks feedback items accessed by said first user and, feedback items yet to be accessed by said first user; and provides indication to a user as to feedback items that remain to be accessed.

21. A computer program product for performing collaborative document development, the computer program product comprising:
a storage medium readable by a processing circuit and storing instructions for processing by the processing circuit for performing a method comprising:
storing, in a memory storage device, a document authored by a first user via a document editing tool;
accessing, by at least two second users via respective client devices, said stored document;
entering feedback content, by each said second user, relating to said accessed document or one or more sub-portions of said document via respective said document editing tools;
storing said feedback content entered by each said second users as individual feedback items in said memory storage device,
specifying, by said first user via said first editing tool, particular feedback content directed to said document or sub-portions thereof; and in response,
aggregating any stored feedback items directed to said specified document or a sub-portion thereof;
presenting, via said first editing tool, said document including said aggregated individual feedback items associated with a specified said document or sub-portion thereof for said first user,
wherein said first user obtains feedback generated from the at least two second users directly in said document for editing via said document editing tool.

22. The computer program product as claimed in claim 21, wherein prior to storing said individual feedback items, said method comprising:
generating a metadata associated with said entered feedback items;
publishing said individual feedback items and associated metadata in said memory storage device.

23. The computer program product as claimed in claim 22, wherein said aggregating stored feedback items comprises:
grouping related stored feedback items by their associated metadata prior to accessing.

24. The computer program product as claimed in claim 24, wherein a said published associated metadata associated with feedback items include associated metadata attributes, said specifying comprising:
implementing a filter to specify metadata attributes to enable filtering out of particular feedback items from said document, said filter enabling said grouping of specific feedback items based on said specified metadata attributes.

25. The computer program product as claimed in claim 24, wherein said metadata attributes includes: a feedback item identifier (ID); information about a second user providing said feedback comments; a feedback target including a document or sub-portion thereof; a feedback type; a feedback status; and, a feedback content.
